(19) United States
(12) Patent Application Publication
(10) Pub. No.: US 2009/0021561 A1
(43) Pub. Date: Jan. 22, 2009

(54) INKJET PRINT HEAD AND MANUFACTURING METHOD THEREOF

(75) Inventors: Myong Jong Kwon, Suwon-si (KR); Tae Jin Kim, Seongnam-si (KR); Eun Bong Han, Suwon-si (KR); Sung Joon Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/120,352

(22) Filed: May 14, 2008

(30) Foreign Application Priority Data
Jul. 16, 2007 (KR) 2007-71307

(51) Int. Cl. B41J 2/05; G11B 5/127

(52) U.S. Cl. 347/63; 216/27

(57) ABSTRACT

An inkjet print head and manufacturing method includes a substrate, an insulating layer formed on a surface of the substrate to have an electrode formation space, an electrode formed in the electrode formation space to be positioned on the same plane with the insulating layer, a heater formed on upper surfaces of the insulating layer and the electrode, and a passivation layer formed on the insulating layer and the heater. The heater is formed to be flat on the insulating layer and the electrodes, thereby reducing the thickness of the passivation layer. Further, copper having relatively high electric conductivity is used as a material of the electrodes, which apply current to the heater to generate heat, instead of aluminum, thereby increasing a degree of freedom in the thickness of the electrodes. Further, uniform current can be applied to the respective heaters at different positions in single firing and full firing of ink, thereby reducing entire input energy and also improving ink ejection stability and reliability of the inkjet print head.

### CROSS-REFERENCE TO RELATED APPLICATIONS

This application claims the benefit and priority under 35 U.S.C. §119(a) of Korean Patent Application No. 2007-0071307, filed in the Korean Intellectual Property Office on Jul. 16, 2007, the disclosure of which is incorporated herein by reference, in its entirety.

### BACKGROUND OF THE INVENTION

1. Field of the Invention

The present general inventive concept relates to an inkjet print head and a manufacturing method thereof, and more particularly, to a thermal driving type inkjet print head and a manufacturing method thereof.

2. Description of the Related Art

An inkjet print head is a device which ejects ink droplets onto a printing medium at desired positions to form an image of a specific color. The inkjet print heads are largely classified into two types: a thermal driving type and a piezoelectric driving type, according to a mechanism of ejecting the ink droplets. The thermal driving type inkjet print head generates bubbles in the ink using a heat source and ejects the ink droplets by an expansive force of the bubbles. The piezoelectric driving type inkjet print head ejects ink droplets by pressure applied to the ink due to deformation of a piezoelectric element.

A mechanism of ejecting the ink droplets in the thermal driving type inkjet print head will now be explained in detail. When pulse current flows in a heater having a resistor, heat is generated such that the ink adjacent to the heater instantly experiences a temperature increase to about 300° C. As the ink is boiled it generates bubbles. The generated bubbles expand and exert pressure on the ink within an ink chamber. Accordingly, the ink around a nozzle is ejected from the ink chamber through the nozzle in the form of ink droplets.

Conventional technology discloses an inkjet print head having a structure in which a substrate, an insulating layer, an electrode layer, a heater, a passivation layer, and an anti-passivation layer are sequentially stacked.

The electrode receives an electrical signal from a general CMOS logic circuit and a power transistor and transmits the electrical signal to the heater. The passivation layer is formed on the electrode and the heater to protect them. The passivation layer protects the electrode and the heater from electrical insulation and external impact. The anti-passivation layer prevents the electrode and the heater from being damaged by a cavitation force generated when the ink bubbles generated due to heat energy are extinguished.

Ink is supplied to the upper surface of the substrate from the lower surface of the print head substrate through an ink supply path. The ink supplied through the ink supply path reaches an ink chamber formed as a chamber plate. The ink temporarily stored in the ink chamber is instantly heated by the heater which receives an electrical signal through the electrode connected to an external circuit to generate heat. The ink generates explosive bubbles, and a portion of the ink in the ink chamber is ejected to the outside of the print head through the ink nozzle formed above the ink chamber.

Recently, the inkjet print head has required a line width printer for high speed, high integration and high quality. The line width printer requires a plurality of nozzles. The nozzles should eject ink at the same time within practical limits. In this case, a large amount of energy is applied to the printer, and it may cause heat accumulation to reduce printing performance and quality. Thus, the print head is required to maintain low energy in ejecting ink.

There is a method of reducing the thickness of the passivation layer to reduce heat accumulation.

However, since aluminum is conventionally used as a material of the electrode layer, and has low electric conductivity, and the electrode and the heater are positioned on different levels of the structure, the passivation layer should have a predetermined thickness for the above-mentioned characteristics and structure. Accordingly, there is a limit in reducing the thickness of the passivation layer.

Further, when the nozzles eject ink at the same time, it is necessary to maintain a small variation in current applied to the respective heaters so as to ensure uniformity in the printing quality.

However, conventionally, since aluminum (Al) is used as material of the electrode layer, there is a large variation in current when the nozzles simultaneously eject ink. It causes a reduction in ejection performance and reliability of the inkjet print head.

As a method of minimizing variation in current applied to the respective heaters when the nozzles simultaneously eject ink, the thickness of the electrode may be increased. However, when increasing the thickness of the electrode, the passivation layer having the same thickness should be formed on the electrode and the heater. When the passivation layer is formed on the electrode and the heater, step coverage deteriorates reducing the reliability of the heater. Further, in increasing the thickness of the passivation layer for step coverage, input energy used to drive the heater increases, thereby causing heat accumulation.

### SUMMARY OF THE INVENTION

The present general inventive concept provides an inkjet print head capable of reducing input energy while improving reliability and ejection performance of the inkjet print head and a manufacturing method thereof.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet print head including a substrate, an insulating layer formed on a surface of the substrate to have an electrode formation space, an electrode formed in the electrode formation space to be positioned on the same plane with the insulating layer, a heater formed on upper surfaces of the insulating layer and the electrode, and a passivation layer formed on the insulating layer and the heater.

The foregoing and/or other aspects and utilities of the present general inventive concept may be achieved by providing a method of manufacturing an inkjet print head including forming an insulating layer on a surface of a substrate, forming an electrode formation space in the insulating layer, forming an electrode to cover the insulating layer and the electrode formation space, planarizing upper surfaces of the insulating layer and the electrode such that the upper surfaces of the insulating layer and the electrode are positioned on the same plane, forming a heater on the upper surfaces of the insulating layer and the electrode, and forming a passivation layer on an upper surface of the heater.

The foregoing and/or other aspects and utilities of the present general inventive concept may be achieved by providing an inkjet print head including a substrate, an insulating layer formed on a surface of the substrate, an electrode formed by etching away a portion of the insulating layer and electroforming a layer of copper, a heater formed on upper surfaces of the insulating layer and the electrode and a passivation layer formed on the insulating layer and the heater.

The foregoing and/or other aspects and utilities of the present general inventive concept may be achieved by providing a method of manufacturing an inkjet print head, including forming an insulating layer on a surface of a substrate, forming an electrode formation space in the insulating layer, forming an electrode to cover the insulating layer and the electrode formation space, planarizing upper surfaces of the insulating layer and the electrode such that the upper surfaces of the insulating layer and the electrode are positioned on the same plane and forming a heater on the upper surfaces of the insulating layer and the electrode.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 illustrates a cross-sectional view showing a configuration of an inkjet print head according to an embodiment of the present general inventive concept; and

FIGS. 2 to 9 illustrate cross-sectional views showing sequential processes of manufacturing the inkjet print head according to the embodiment of the present general inventive concept illustrated in FIG. 1.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

Hereinafter, an embodiment of the present general inventive concept will be described in detail with reference to the accompanying drawings.

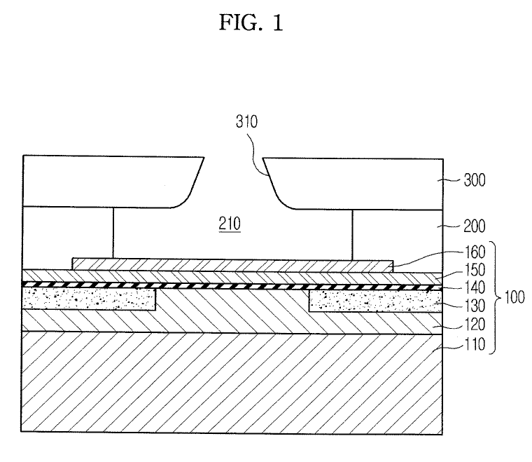

FIG. 1 illustrates a cross-sectional view showing a configuration of an inkjet print head according to one embodiment of the present general inventive concept. Although only a unitary structure of the inkjet print head is depicted in the drawings, a plurality of ink chambers and a plurality of nozzles are arranged in a row or in two rows in the inkjet print head manufactured in a chip shape, and may be arranged in three or more rows to improve a resolution.

As illustrated in FIG. 1, the inkjet print head manufactured according to one embodiment of the present general inventive concept has a structure in which a base plate 100, a flow path plate 200 and a nozzle plate 300 are sequentially stacked.

The flow path plate 200 includes an ink chamber 210 which is filled with ink supplied from an ink storage unit through an ink flow path.

The nozzle plate 300 includes a nozzle 310 formed at a position corresponding to the ink chamber 210 to eject ink.

The base plate 100 is formed by stacking an insulating layer 120, electrodes 130, a heater 140, a passivation layer 150, an anti-cavitation layer 160 or the like on a substrate 110. A silicon wafer, which is widely used in the manufacture of an integrated circuit, is used as the substrate 110.

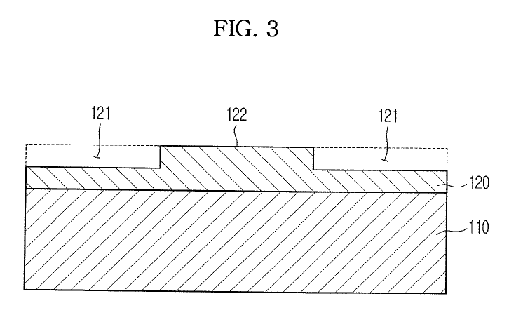

In this case, the insulating layer 120 not only serves to insulate the substrate 110 from the heater 140, but also serves as a thermal insulating layer to prevent heat energy generated in the heater 140 from leaking toward the substrate 110. The insulating layer 120 is partially protruded (for example, see protrusion 122 at FIG. 3) such that the electrodes can be divided and mounted thereon. The insulating layer 120 is formed of a silicon nitride film (SiNx) or a silicon oxide film (SiOx) with a high insulating property on the surface of the substrate 110. Further, the electrodes 130 are respectively formed at opposite sides of a protruding portion of the insulating layer 120 such that the protruding portion is exposed. In this case, the upper surfaces of a pair of the electrodes 130 and the upper surface of the exposed portion of the insulating layer 120 are positioned on the same plane. The electrodes 130 are formed of copper (Cu) with a high heat conductivity to apply current to the heater 140 such that ink in the ink chamber 210 is heated to generate bubbles.

Further, the heater 140 is formed on the upper surfaces of the exposed insulating layer 120 and the electrodes 130. The heater 140 may be formed in a rectangular or circular shape.

Further, the passivation layer 150 is formed on the electrodes 130 and the heater 140 to protect them. The passivation layer 150 is formed of a silicon nitride film (SiNx) to prevent the electrodes 130 and the heater 140 from being oxidized or directly contacted with ink.

Further, the anti-cavitation layer 160 is formed on the upper surface of the passivation layer 150 at a portion where the ink chamber 210 is formed. The upper surface of the anti-cavitation layer 160 forms the lower surface of the ink chamber 210 to prevent the heater 140 from being damaged by high pressure generated when the bubbles in the ink chamber 210 are extinguished. The anti-cavitation layer 160 is formed of tantalum (Ta).

Hereinafter, a method of manufacturing the inkjet print head having the above configuration according to the present general inventive concept will be described.

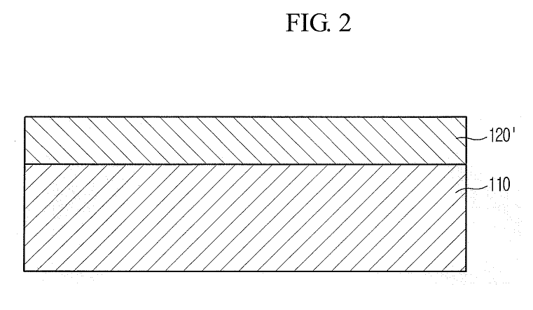

FIGS. 2 to 9 illustrate cross-sectional views showing sequential processes of manufacturing the inkjet print head according to the embodiment of the present general inventive concept.

First, referring to FIG. 2, in this embodiment, a silicon wafer processed to have a predetermined thickness is used as the substrate 110. The silicon wafer is widely used in the manufacture of the semiconductor devices and is effective in mass production. Meanwhile, FIG. 2 depicts a portion of the silicon wafer. The inkjet print head according to the present general inventive concept may be manufactured as several tens to several hundreds of chips on a single wafer.

Further, a preliminary insulating layer 120′ is formed on the upper surface of the prepared silicon substrate 110. The preliminary insulating layer 120′ may be formed of a silicon oxide film (SiOx) or a silicon nitride film (SiNx) having a thickness of about 5000 Å to 50000 Å, which is formed on the surface of the substrate 110 when the surface of the substrate 110 is oxidized at a high temperature. The preliminary insulating layer 120′ is deposited by a sputtering method or chemical vapor deposition (CVD). The preliminary insulating layer 120′ is formed of multi-layer materials. For example, when a silicon oxide film (SiOx) is used as the preliminary insulating layer 120′, a silicon nitride film (SiNx) is used as an etch stop layer on the preliminary insulating layer 120′ to stop etching.

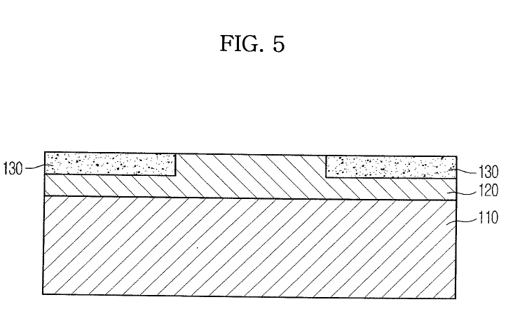

As illustrated in FIG. 3, after the preliminary insulating layer 120′ is formed on the substrate 110, an etching mask is formed by patterning through a photolithography process. Then, a portion of the preliminary insulating layer 120′, which is exposed by the etching mask, is removed by dry etching or wet etching. Hence, insulating layer 120 is formed. The etching mask is removed by an ashing and strip process serving as a general photoresist removal process. Accordingly, as illustrated in FIG. 3, portions 121 represented by dotted lines are formed at opposite sides of a protruding portion 122 of the insulating layer 120, wherein the electrodes 130 are subsequently formed at the portions 121 (FIG. 5).

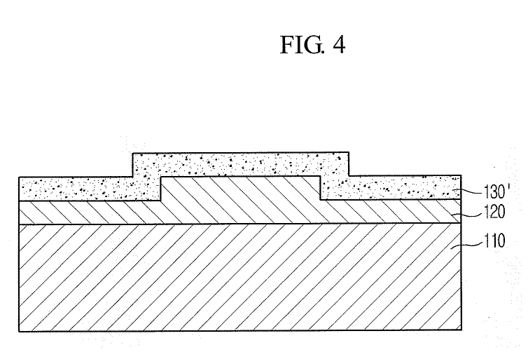

As illustrated in FIG. 4, a preliminary electrode 130′ having a predetermined thickness is formed on the upper surface of the insulating layer 120 having a shape illustrated in FIG. 3 to form subsequently the electrodes 130 (see FIG. 5). The preliminary electrode 130′ is formed of copper (Cu) by electroforming. The preliminary electrode 130′ has a thickness equal to or smaller than a thickness of the insulating layer 120, according to the general inventive concept, as described above.

After the preliminary electrode 130′ is formed, as illustrated in FIG. 4, the preliminary electrode 130′ is planarized by a chemical mechanical polishing (CMP) process until copper (Cu) is removed from the exposed surface of the insulating layer 120. Hence the electrode 130 of FIG. 5 is achieved. The CMP process is a polishing process technology obtained by mixing a mechanical removal process and a chemical removal process. In this case, the exposed portion of the insulating layer 120 serves as an etch stop layer to allow copper (Cu) to have a uniform thickness. That is, the copper electrode 130 is patterned by the CMP process. The exposed portion of the insulating layer 120 and the electrodes 130 are planarized by the CMP process, and the upper surfaces thereof are positioned on the same plane.

Copper (Cu) is used as a material of the electrodes 130 instead of aluminum (Al) since Cu electrodes have a much smaller variation in current applied to respective heaters in each group compared to Al electrodes. As an experiment result, in case of using the Al electrodes, a current variation of 1.80% is obtained in single firing and a maximum current variation of 6.49% is obtained in full firing. However, in case of using the Cu electrodes having the same thickness as that of the Al electrodes instead of the Al electrodes, a small current variation is obtained in both single firing and full firing differently from the Al electrodes. Particularly, in full firing, a current variation in the respective heaters at different positions according to the number of driving operations is also improved by about 53%. Further, if the thickness of the Cu electrodes is increased to 30000 Å, a maximum current variation in the respective heaters at different positions is reduced to 1.16%, and it means a current variation is improved by about 460% compared to a case of using the Al electrodes having a thickness of 8000 Å. That is, in full firing, current is uniformly applied to the heaters at different positions, thereby obtaining uniform ejection performance and excellent printing quality. Further, heat of the inkjet head due to a wiring resistance is reduced, and entire input energy is also reduced by about 3˜7% according to the thickness of the Cu electrodes. Thus, heat of the inkjet head generated in simultaneous ejection is reduced, thereby improving reliability.

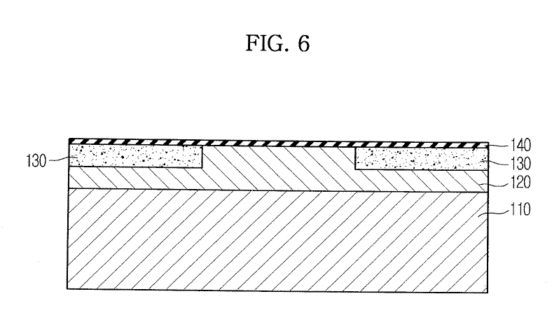

As illustrated in FIG. 6, the heater 140 is formed on the exposed portion 122 of the insulating layer 120 and the upper surfaces of the electrodes 130 in a longitudinal direction. In this case, since the exposed portion of the insulating layer 120 and the upper surfaces of the electrodes 130 are positioned on the same plane, the heater 140 is formed to be flat on the exposed portion of the insulating layer 120 and the upper surfaces of the electrodes 130 in a longitudinal direction. The heater 140 may be formed of at least one selected from a group consisting of titanium nitride (TiN), tantalum nitride (TaN), tantalum-aluminum alloy (TaAl) and tungsten silicide by CVD such as sputtering.

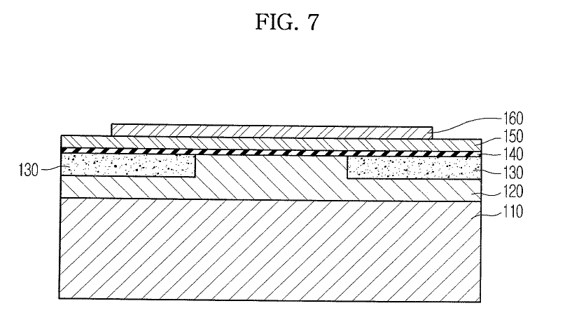

As illustrated in FIG. 7, after the heater 140 is formed, the passivation layer 150 is formed on the surface of the heater 140. The passivation layer 150 is formed by depositing a silicon nitride (SiN) film at a predetermined thickness by physical vapor deposition (PVD) or chemical vapor deposition (CVD) to protect the electrodes 130 and the heater 140.

After the passivation layer 150 is formed, the anti-cavitation layer 160 is formed on the passivation layer 150. The anti-cavitation layer 160 is formed on the passivation layer 150 by depositing, for example, tantalum (Ta) at a predetermined thickness by sputtering. After a photoresist is coated on the surface of the deposited tantalum, the photoresist is patterned by a photolithography process to form an etching mask. A portion of the tantalum, which is exposed by the mask, is removed by dry or wet etching. Then, the etching mask is removed by an ashing and strip process serving as a general photoresist removal process, thereby forming the anti-cavitation layer 160. In this case, since the heater 140 is formed to be flat, even though the passivation layer 150 has a small thickness, it is possible to obtain good step coverage characteristics. Accordingly, it is possible to minimize the thickness of the passivation layer 150, thereby reducing input energy. Further, when the heater 140 has durability against ink, the heater 140 can protect the electrodes 130 and, thus, it is possible to omit an additional passivation layer.

The base plate 100 including the substrate 110, the insulating layer 120, the electrodes 130, the heater 140, the passivation layer 150 and the anti-cavitation layer 160 is completed through the processes illustrated in FIGS. 2 to 7.

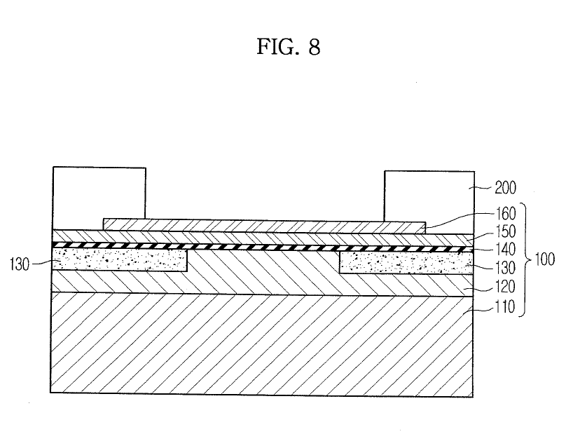

Next, after the base plate 100 is completed, as illustrated in FIG. 8, the flow path plate 200 is formed to define an ink flow path on the base plate 100. Specifically, first, a negative photoresist is coated on the base plate 100 at a predetermined thickness to form a photoresist layer. The photoresist layer is exposed to ultraviolet ray (UV) using the ink chamber and a photomask having a restrictor pattern such that the photoresist layer is developed. Then, a non-exposed portion of the photoresist layer is removed, thereby forming the flow path plate 200.

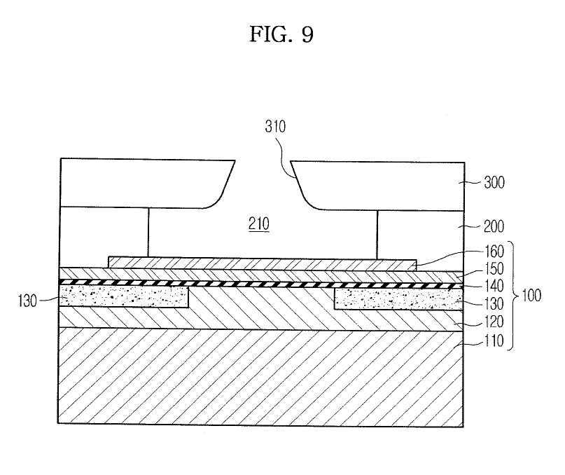

Then, as illustrated in FIG. 9, the nozzle plate 300 is formed on the flow path plate 200. Specifically, first, a sacrificial layer is formed on the flow path plate 200 to have a height larger than that of the flow path plate 200. In this case, the sacrificial layer is formed by coating a positive photoresist at a predetermined thickness by a spin coating method. Then, the upper surfaces of the sacrificial layer and the flow path plate 200 are formed to have the same height by a CMP process. Then, a negative photoresist is formed on the flow path plate 200 and the sacrificial layer with the planarized upper surfaces to have a thickness capable of ensuring a sufficient length of the nozzle and providing strength to withstand a variation in pressure inside the ink chamber 210. Then, the photoresist layer formed of the negative photoresist is exposed to light using a photomask. Then, the photoresist layer is developed and a non-exposed portion of the photoresist layer is removed, thereby forming the nozzle 310. Further, a portion hardened by exposure remains and forms the nozzle plate 300. Thereafter, an etching mask is formed on the rear surface of the substrate 110 in order to form an ink supply hole. Then, the rear surface the substrate 110 is etched using the etching mask to form the ink supply hole passing through the substrate 110. Finally, the sacrificial layer is removed by a solvent, thereby completing the inkjet print head having a configuration illustrated in FIG. 9 according to one embodiment of the present general inventive concept.

As described above, according to the present general inventive concept, the heater 140 is formed to be flat on the insulating layer 120 and the electrodes 130. Accordingly, it is possible to reduce the thickness of the passivation layer 150. Further, copper having relatively high electric conductivity is used as a material of the electrodes 130, which apply current to the heater 140 to generate heat, instead of aluminum. Accordingly, it is possible to increase a degree of freedom in the thickness of the electrodes 130. Further, since uniform current can be applied to the respective heaters 140 at different positions in single firing and full firing of ink, it is possible to reduce entire input energy and also possible to improve ink ejection stability and reliability of the inkjet print head.

Although embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet print head comprising:
a substrate;
an insulating layer formed on a surface of the substrate to have an electrode formation space;
an electrode formed in the electrode formation space to be positioned on the same plane with the insulating layer;
a heater formed on upper surfaces of the insulating layer and the electrode; and
a passivation layer formed on the insulating layer and the heater.

2. The inkjet print head of claim 1, wherein the insulating layer includes a first insulating layer formed of a silicon oxide film (SiOx) on the substrate and a second insulating layer formed of a silicon nitride film (SiNx) on the first insulating layer.

3. The inkjet print head of claim 2, wherein the electrode is formed to have the same height as that of the second insulating layer.

4. The inkjet print head of claim 1, wherein the insulating layer is formed to have a thickness of 5000 Å to 50000 Å.

5. The inkjet print head of claim 4, wherein the electrode has a thickness equal to or smaller than that of the insulating layer.

6. The inkjet print head of claim 1, wherein the electrode is formed in the electrode formation space to be positioned at the same height as that of the upper surface of the insulating layer.

7. The inkjet print head of claim 6, wherein the electrode is copper.

8. The inkjet print head of claim 1, wherein the passivation layer is formed of a silicon nitride film (SiNx).

9. The inkjet print head of claim 1, further comprising an anti-cavitation layer which is formed of tantalum (Ta) on a surface of the passivation layer.

10. A method of manufacturing an inkjet print head, comprising:
forming an insulating layer on a surface of a substrate;
forming an electrode formation space in the insulating layer;
forming an electrode to cover the insulating layer and the electrode formation space;
planarizing upper surfaces of the insulating layer and the electrode such that the upper surfaces of the insulating layer and the electrode are positioned on the same plane;
forming a heater on the upper surfaces of the insulating layer and the electrode; and
forming a passivation layer on an upper surface of the heater.

11. The method of claim 10, wherein the upper surfaces of the insulating layer and the electrode are planarized by a chemical mechanical polishing (CMP) process such that the upper surfaces of the insulating layer and the electrode are positioned on the same plane.

12. The method of claim 10, wherein the electrode is formed in the electrode formation space on the insulating layer by electroforming.

13. The method of claim 10, wherein the heater is formed by a sputtering method or a chemical vapor deposition (CVD) method.

14. The method of claim 10, further comprising forming an anti-cavitation layer made of tantalum (Ta) on a surface of the passivation layer

15. The method of claim 10, further comprising:
forming a flow path plate to define an ink flow path on the substrate with the insulating layer, the electrode, the heater and the passivation layer formed thereon;
forming a sacrificial layer on the substrate with the flow path plate formed thereon to cover the flow path plate;
planarizing upper surfaces of the flow path plate and the sacrificial layer by chemical mechanical polishing (CMP) process;
forming a nozzle plate on the upper surfaces of the flow path plate and the sacrificial layer;
forming an ink supply hole in the substrate with the nozzle plate formed thereon; and
removing the sacrificial layer.

16. An inkjet print head comprising:
a substrate;
an insulating layer formed on a surface of the substrate;
an electrode formed by etching away a portion of the insulating layer and electroforming a layer of copper;
a heater formed on upper surfaces of the insulating layer and the electrode; and
a passivation layer formed on the insulating layer and the heater.
